(19) United States
(12) Patent Application Publication
(10) Pub. No.: US 2002/0184471 A1
(43) Pub. Date: Dec. 5, 2002

(54) Semiconductor integrated circuit and computer-readable recording medium

(76) Inventors: Hiroshi Hatae, Toda (JP); Hiromi Watanabe, Mitaka (JP); Yukifumi Kobayashi, Kodaira (JP)

Correspondence Address: REED SMITH LLP, Suite 1400, 3110 Fairview Park Drive, Falls Church, VA, 22042, US

(21) Appl. No.: 10/080,578

(22) Filed: Feb. 25, 2002

(30) Foreign Application Priority Data
May 31, 2001 (JP) 2001-163575

(51) Int. Cl. G06F 15/00

(52) U.S. Cl. 712/22

(57) ABSTRACT

A semiconductor integrated circuit includes a single instruction multiple data (SIMD) unit conducting a concurrent operation for a plurality of data items, a data buffer connectable to the SIMD unit, and a data transfer control unit for controlling transfer of data for the data buffer thereby, the data transfer control unit controls the transfer of data for a subsequent operation to the buffer in concurrence with the operation of the SIMD unit for the plural data items read from the data buffer and in concurrent with the operation of the SIMD unit, data for a subsequent operation is transferred to the data buffer.

### BACKGROUND OF THE INVENTION

The present invention relates to a semiconductor integrated circuit including a single instruction multiple data (SIMD) processing device, and in particular, to a technique which increases processing efficiency thereof and which facilitates designing of the semiconductor integrated circuit, for example, to a technique which can be effectively applied to a semiconductor circuit of large-scale integration in which data of images can be compressed and expanded according to a moving picture experts group (MPEG) specification.

Various services using image compression and expansion according to MPEG2 and MPEG4 have been put to practices at present. These specifications require processing to detect moving of an image. This also requires quite a large number of pixel processing steps. The operations are efficiently achieved through concurrent processing by a processor. Such a processor has architecture to conduct SIMD processing. There exists, for example, a processor having an instruction set including MMX instructions. For example, Latest Microprocessor Technologie of May 10, 1996 describes the MMX technique in pages 202 to 208 thereof. In the article, an operator usually operating as a 64-bit operator is used, to execute an MMX instruction, functionally as eight 8-bit operators, four 16-bit operators, or two 32-bit operators. When image data is processed, for example, in 8-bit processing unit, the 64-bit operator can be used as eight 8-bit operators in a parallel fashion. In this case, operation performance is eight times that of the case in which the 64-bit operator is used as a 64-bit operator as usual. Therefore, quite a large volume of image data can be more efficiently processed.

The present inventor examined SIMD processing in the image data compression and expansion as below.

First, in the processing of data of images, eight bits are ordinarily used to represent each pixel of the data only having positive values. Therefore, image data is generally stored as 8-bit data without any sign in a memory or the like. However, during the data compression and expansion, it is necessary to process data which may take a negative value such as results of a discrete cosine transform (DCT) and an inverse DCT (IDCT). The operator must execute processing of data with a sign. In the case of 8-bit image data, a sign of one bit is added to the data. According to the MMX architecture, in the SIMD processing of eight 8-bit data items, only 7-bit data items can be actually processed. The sign bit cannot be processed. To appropriately process 8-bit data, a 64-bit operator must be divided into four 16-bit operators to execute concurrent processing in 16-bit unit. The processing performance is reduced to one half that of the original processing performance. This results in an unused processing resource of 7 high-order bits of 16 bits in the operator.

Second, in the image data compression and expansion, the data must be inputted to the operator in pixel unit. To satisfy the requirement in the conventional SIMD operator, it is not conducted that data of the pertinent area is directly obtained from the memory to be internally transferred to a register of the SIMD operator. It is necessary in that data is once read from the memory in a multiple of a memory access unit, namely, in 32-bit or 64-bit boundary unit and is stored in a register of the SIMD unit. Thereafter, to shape the data, a combination of instructions such as a data shift instruction are executed to obtain data necessary for the processing. The processing is executed by software, namely, by executing instructions, and hence lowers the data processing efficiency.

Third, the present inventor examined processing to solve the second problem described above in which before data is loaded in a register of the SIMD operator, image data of a pertinent image area is obtained from a buffer area. This additionally requires processing to store the image data from the image memory in the buffer memory. The data shaping is not required and hence the processing time is reduced. However, the additional processing appears as a problem to be solved.

### SUMMARY OF THE INVENTION

It is therefore an object of the present invention to provide a semiconductor integrated circuit capable of efficiently execute the SIMD processing.

Another object of the present invention is to provide a semiconductor integrated circuit in which even when the bit extension is necessary for data in the SIMD processing, all processing resources can be efficiently used, without any processing resource kept unused.

Still another object of the present invention is to provide a semiconductor integrated circuit in which a combination of a data shift instruction is not required to shape data, for example, to align necessary data in a data register of the SIMD unit to thereby efficiently operate the SIMD operator.

Another object of the present invention is to provide a semiconductor integrated circuit in which even when the data shaping is executed using additional processing to store image data from an image memory in a buffer memory, processing efficiency of the SIMD operator is not lowered.

Further another object of the present invention is to provide a computer-readable recording medium having stored thereon a circuit module data of a semiconductor integrated circuit capable of helping design the semiconductor integrated circuit for the objects of the present invention.

(1) A semiconductor integrated circuit according to a first aspect of the present invention includes a single instruction multiple data (SIMD) unit capable of conducting a concurrent operation for a plurality of data items; a data buffer connectible to the SIMD unit; and a data transfer control unit for controlling transfer of data for the data buffer, wherein the data transfer control unit can control transfer of data for a subsequent operation to the buffer in concurrence with the operation of the SIMD unit for the plural data items read from the data buffer.

Image data obtained from a pertinent area of an image memory is transferred to the data buffer under data transfer control of the data transfer control unit. The image memory includes a large-capacity, low-speed memory such as a dynamic RAM (DRAM) and a synchronous DRAM. The data buffer includes a high-speed memory such as a static RAM (SRAM). The image memory transferred to the data buffer is then fed to the SIMD unit and is processed therein using other image data or coefficient data. In concurrence with the processing by the SIMD operator, data for subsequent processing is transferred to the data buffer. Therefore, the operation of the SIMD unit is not interrupted by the internal transfer of the data to the data buffer. That is, the SIMD operator can continuously conduct its operation, and hence efficiency of the SIMD operation is increased.

In a concrete embodiment, the data buffer includes a dual-port unit including a first port and a second port, the first port being connected via a first bus to the SIMD unit, the second port being connected via a second bus to the data transfer control unit. Since the first and second buses are separated from each other, it is guaranteed that the operation of the SIMD operator and the data transfer to the data buffer for a subsequent operation are concurrently carried out.

The first port can concurrently input and output the plurality of data items for the first bus; and the second port can concurrently input and output the plurality of data items for the second bus. The number of bus or memory cycles necessary for the data transfer can be minimized, and hence the SIMD operation efficiency is maximized.

The SIMD unit may include a first data register and a second data register which are connected to the first bus and which are capable of concurrently latching the plurality of data items and an operator for receiving the plurality of data items respectively latched by the first and second data registers and for conducting a concurrent operation for the data items. For example, in the data compression of image data according to MPEG2 and MPEG4, the image data is fed from the image memory to the first and second data registers to thereafter execute the predetermined processing. In the data expansion of image data, the image data is fed from the image memory to the first data register and the data resulted from the inverse DCT is fed to the second data register to thereafter execute the predetermined processing.

A central processing unit for conducting operation control for the SIMD unit and access control via the first bus to the data buffer may be disposed as an on-chip device. To conduct the control operations, it is only necessary to use software.

(2) A semiconductor integrated circuit according to a second aspect of the present invention pays attention to bit extension such as code extension for image data to be processed with a signed DCT coefficient or a signed result of IDCT. That is, the semiconductor integrated circuit includes a single instruction multiple data (SIMD) unit conducting a concurrent operation for a plurality of data items, a data buffer connected via a first bus to the SIMD unit, and a data transfer control unit connected via a second bus to the data buffer, wherein the data transfer control unit includes a bit extension unit for conducting bit extension for each of the plurality of data items transferred via the second bus to the data buffer. When the code extension of unsigned data is taken into consideration in the operation with the signed data, the operation can be conducted by software on a CPU or the like. However, in such a case, the number of bits of code extension data must be determined in consideration of a word or byte boundary of data with respect to the resource of the SIMD operation. When the code extension is conducted using a bit extension unit of the data transfer control unit via a local second bus to the data buffer, almost no load is imposed on the CPU. Moreover, in consideration of the configuration in which the first bus is used as a shared unit by other than the SIMD unit, namely, also by other operating units and/or storages, even if an additional load is imposed on the transmission line due to the addition of the bit extension unit, the load is imposed only on the local second bus. That is, this does not exert any influence on the signal transmission to the SIMD unit.

The bit extension unit conducts 1-bit code extension, for example, according to a lower-most bit of the data.

By using a configuration for the bit extension unit in which bit extension is conducted for the plurality of data items in a concurrent fashion, it is not necessary to conduct the bit extension for each data item, and hence the bit extension can be conducted at a time while the plurality of data items are being transmitted through a data transfer path in the data transfer controller.

In an operation to obtain data from a desired image area of image data to use the obtained image data as an object of the SIMD operation, there possibly occurs a case in which only the necessary image data cannot be directly read from the image memory because of, for example, the memory access word boundary. In this case, it is possible to align data by repeatedly conducting a sequence of an operation to read data from the memory and an operation to shift the data. The SIMD device can also execute the processing by the data register and the operating unit thereof using a plurality of operation cycles. However, the inherent SIMD processing efficiency is lowered. To overcome this difficulty, when a data aligner is disposed at a stage before the bit extension unit for the plurality of data items, the data alignment can be simply implemented without increasing the processing load of the CPU. Additionally, the data alignment is completely carried out before the data buffer, the increase in the number of memory accesses due to the data alignment does not exert any influence on the SIMD processing efficiency.

In the expansion of image data such as MPEG2 and/or MPEG4 image data, an SIMD operation is carried out for IDCT resultant data and unsigned image data using code extension. To write the expanded image information in an image memory, the sign of the operation result is not necessary. To remove the sign, a bit remover is favorably disposed, for example, in the data transfer controller, for each of the plurality of data items read from the data buffer to be fed through the second bus. The bit remover removes predetermined bits from the associated data item.

The bit removal unit removes a higher-most bit from the data.

The data buffer includes, for example, a dual-port unit including a first port and a second port, the first port being connected via a first bus to the SIMD unit, the second port being connected via a second bus to the data transfer control unit. In the configuration, when the first port can concurrently input and output the plurality of data items for the first bus and the second port can concurrently input and output the plurality of data items for the second bus, the number of processing cycles required for the data transfer can be minimized.

The SIMD unit may include, for example, a first data register connected to the first bus, the first data register being capable of concurrently latching the plurality of data items; a second data register connected to the first bus, the first data register being capable of concurrently latching the plurality of data items; and an operator for receiving the plurality of data items respectively latched by the first and second data registers and for conducting a concurrent operation for the data items. The semiconductor integrated circuit may include a central processing unit capable of conducting operation control for the SIMD unit and access control via the first bus to the data buffer. The first and second data registers latch, in compression processing of image data, the image data; the first data register latches, in expansion of image data, the image data; and the second data register latches data of inverse discrete cosine transform (IDCT).

(3) A semiconductor integrated circuit according to a third aspect of the present invention pays attention to bit extension such as code extension for image data to be processed with a signed DCT coefficient or a signed result of IDCT. The semiconductor integrated circuit includes a bit extension unit disposed on a data transfer path connecting the data buffer to the SIMD unit for conducting bit extension for each of the plurality of data items to the SIMD unit in a concurrent fashion. Also in this case, since the bit extension is conducted in a parallel fashion for the plurality of data items on the data transfer path, almost no additional load is resultantly imposed on the CPU. However, when the data transfer path on which the bit extension unit is arranged is also commonly used by operating units and/or storages other than the SIMD unit, attention must be paid to the increase in the signal line load on the data transfer path due to the bit extension unit.

(4) A semiconductor integrated circuit according mainly to an aspect of data alignment includes a single instruction multiple data (SIMD) unit capable of conducting a concurrent operation for a plurality of data items; a data buffer connectible to the SIMD unit; a data transfer control unit for controlling transfer of data for the data buffer; and a memory capable of storing image data, wherein the data transfer controller includes a data alignment unit capable of shaping data read from the memory.

(5) The computer-readable recording medium according to an aspect of facilitating the design of a semiconductor integrated circuit using the data transfer controller and the like stores thereon circuit module data to be read by the computer, the data being used to design by a computer a semiconductor integrated circuit to be formed on a semiconductor chip. The circuit module data stored on the recording medium includes graphic pattern data or function description data to form on the semiconductor chip an SIMD section capable of concurrently conducting operation for a plurality of data items, a data buffer connectable to the SIMD section, and a data transfer controller which can control, in concurrence with the operation of the SIMD section, transfer of data for a subsequent operation to the data buffer. By using the circuit module data stored on the recording medium, the semiconductor integrated circuit described in conjunction with (1) above can be easily designed.

Another computer-readable recording medium stores thereon circuit module data to be read by the computer, the data being used to design by a computer a semiconductor integrated circuit to be formed on a semiconductor chip. The circuit module data stored on the recording medium includes graphic pattern data or function description data to form on the semiconductor chip an SIMD section capable of concurrently conducting operation for a plurality of data items, a data buffer connectable to the SIMD section, and a data transfer controller which can control transfer of data for the data buffer and which can conduct bit extension for each of the plurality of data items to be transferred to the data buffer. By using the circuit module data stored on the recording medium, the semiconductor integrated circuit described in conjunction with (2) above can be easily designed.

Further another computer-readable recording medium stores thereon circuit module data to be read by the computer, the data being used to design by a computer a semiconductor integrated circuit to be formed on a semiconductor chip. The circuit module data stored on the recording medium includes graphic pattern data or function description data to form on the semiconductor chip an SIMD section capable of concurrently conducting operation for a plurality of data items, a data buffer connectible to the SIMD section, a data transfer controller to control transfer of data for the data buffer, and a bit extension unit which is disposed on a data transfer path to concurrently transfer the plurality of data items from the data buffer to the SIMD section and which conduct bit extension in a parallel fashion for each of the plural data items. By using the circuit module data stored on the recording medium, the semiconductor integrated circuit described in conjunction with (3) above can be easily designed.

Other objects, features and advantages of the invention will become apparent from the following description of the embodiments of the invention taken in conjunction with the accompanying drawings.

### BRIEF DESCRIPTION OF THE DRAWINGS

The present invention will be more apparent from the following detailed description, when taken in conjunction with the accompanying drawings, in which:

FIG. 1 is a block diagram showing an example of a semiconductor integrated circuit according to the present invention;

FIG. 2 is a block diagram of an example showing in detail a data transfer control unit;

FIG. 3 is a block diagram of an example showing in detail a data input/output circuit in the data transfer control unit;

FIG. 4 is a block diagram of an example showing in detail a bit extension circuit in the data transfer control unit;

FIG. 5 is a block diagram of an example showing in detail a bit remover circuit in the data transfer control unit;

FIG. 6 is a signal timing chart showing operation to transfer image data by the data transfer control unit from an image memory to a buffer random access memory (RAM);

FIG. 7 is an explanatory diagram showing a state of image data stored in the image memory;

FIG. 8 is an explanatory diagram showing a state of image data transferred to the buffer RAM by the data transfer control unit having a code extending function;

FIG. 9 is a block diagram showing an example of an SIMD unit;

FIG. 10 is a signal timing chart showing operation timing of direct memory access (DMA) by the data transfer control unit and a SIMD operation by the SIMD operator;

FIG. 11 is a block diagram showing an example in which a pseudo-dual port memory is used for the buffer memory;

FIG. 12 is a timing chart showing operation timing of the DMA transfer control and the SIMD operation in the example of FIG. 11;

FIG. 13 is a block diagram showing an example in which a code extension and removal circuit is disposed outside the data transfer control unit;

FIG. 14 is a block diagram showing an example in which a code extension and removal circuit is disposed outside the data transfer control unit and the buffer RAM includes two RAM units;

FIG. 15 is a block diagram showing an example in which a data aligner function is added to the data transfer control unit;

FIG. 16 is an explanatory diagram showing a state of data to be aligned in the image memory 17;

FIG. 17 is an explanatory diagram showing a state of aligned image data;

FIG. 18 is an explanatory diagram showing a data layout of the aligned image data using code extension; and

FIG. 19 is an explanatory diagram showing an example of IP module data and a computer used, for example, as an integrated circuit designing tool.

### DESCRIPTION OF THE EMBODIMENTS

Outline of Data Processor

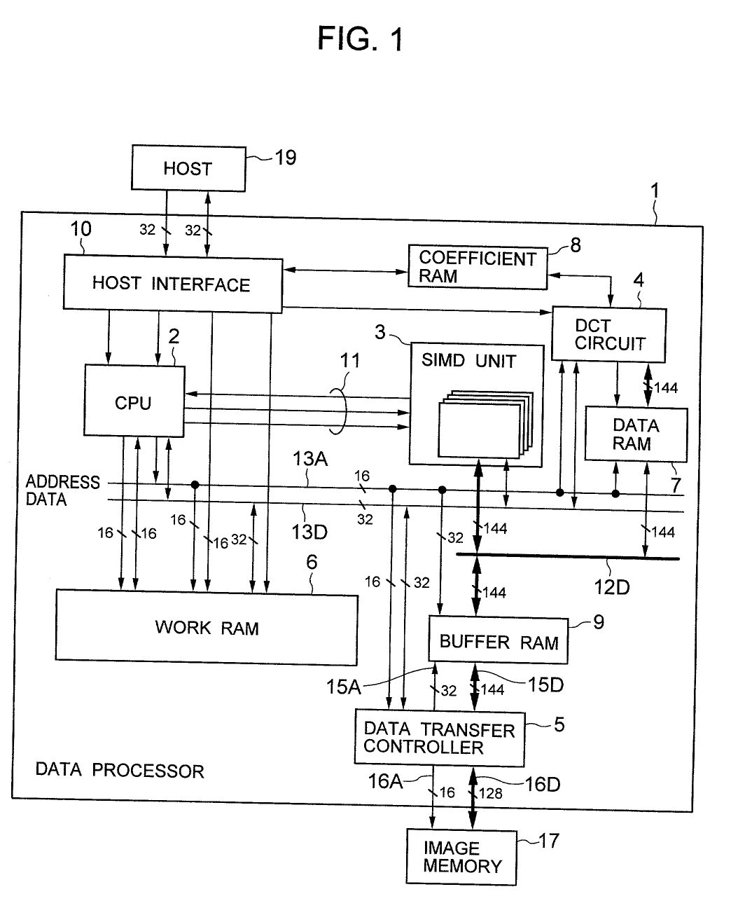

FIG. 1 shows an example of a semiconductor integrated circuit according to the present invention. The circuit is constructed as a data processor customized for image data compression and expansion. The data processor 1 includes one semiconductor substrate or a semiconductor chip and constituent components formed thereon by a CMOS integrated circuit manufacturing technique and the like.

The data processor 1 includes a central processing unit (CPU) 2, an SIMD unit 3, a DCT circuit 4, a data transfer controller 5, a work RAM 6 as a storage of an operating program of the CPU 2 and a work area thereof, a data RAM 7 disposed between the SIMD unit 3 and the DCT circuit 4, a coefficient RAM 8, a buffer RAM 9 arranged as a buffer memory between the SIMD unit 3 and the data transfer controller 5, and a host interface circuit 10.

The SIMD unit 3 conducts a concurrent or parallel operation in the image data compression and expansion under control of the CPU 2. In short, the SIMD unit 3 includes a plurality of operating units. The units respectively fetch mutually different data items to achieve a concurrent operation according to an interpretation result produced by the CPU 2 by interpreting an SIMD command. A reference numeral 11 comprehensively indicates operation control signals between the CPU 2 and the SIMD unit 3.

The SIMD unit 3 communicate data for the SIMD operation and/or data resultant from the operation via the buffer RAM 9 and a first data bus (data bus) 12D with the data RAM 7. Although not limited to, the first data bus 12D is 144-bit wide. The data access via the first data bus 12D is controlled by the CPU 2 via a CPU address bus and a control bus 13A. A reference numeral 13D indicates a CPU data bus.

The data transfer controller 5 controls transfer of data between the buffer RAM 9 and an external image memory or external memory 17. The CPU 2 sets a transfer control condition. The controller 5 is connected via a second data bus 15D and a second address bus 15A to the buffer RAM 9. In this regard, a control bus is not shown in FIG. 1. The controller 5 is connected via a third data bus 16D and a third address bus 16A to the image memory 17. In this regard, a control bus is not shown in FIG. 1.

In the image data compression using, for example, predictive coding between image frames, signed image data is fed from the buffer RAM 9 to the SIMD unit 3 to conduct a differential operation between the image frames. A result of the operation is held in the data RAM 7. According to the result in the data RAM 7, the DCT circuit 4 calculates DCT coefficients. The coefficients are fed via the coefficient RAM 8 to establish a correspondence with pixels of the image frame and are delivered via the host interface 10 to the host 19.

In the image data expansion, signed image data of a standard or reference frame is fed from the image memory 17 to be temporarily stored in the buffer RAM 9. At timing synchronized therewith, the associated coefficient data items are sequentially supplied from the host 19 via the coefficient RAM 8 to the DCT circuit 4. The circuit 4 conducts an IDCT operation for the coefficient data items and resultant data items are temporarily stored in the data RAM 7. The SIMD unit 3 receives the IDCT resultant data and the signed image data from the buffer RAM 9 to decode the image data. Resultantly, the image data expanded as above is transferred to the buffer RAM 9.

The data transfer controller 5 controls the data transfer between the buffer RAM 9 and the image memory 17, conducts the code extension for the image data transferred from the image memory 17 to the buffer RAM 9, and achieves the code removal for the signed image data which are transferred from the buffer RAM 9 to the image memory 17 and which are expanded and stored in the buffer RAM 9.

Data Transfer Controller

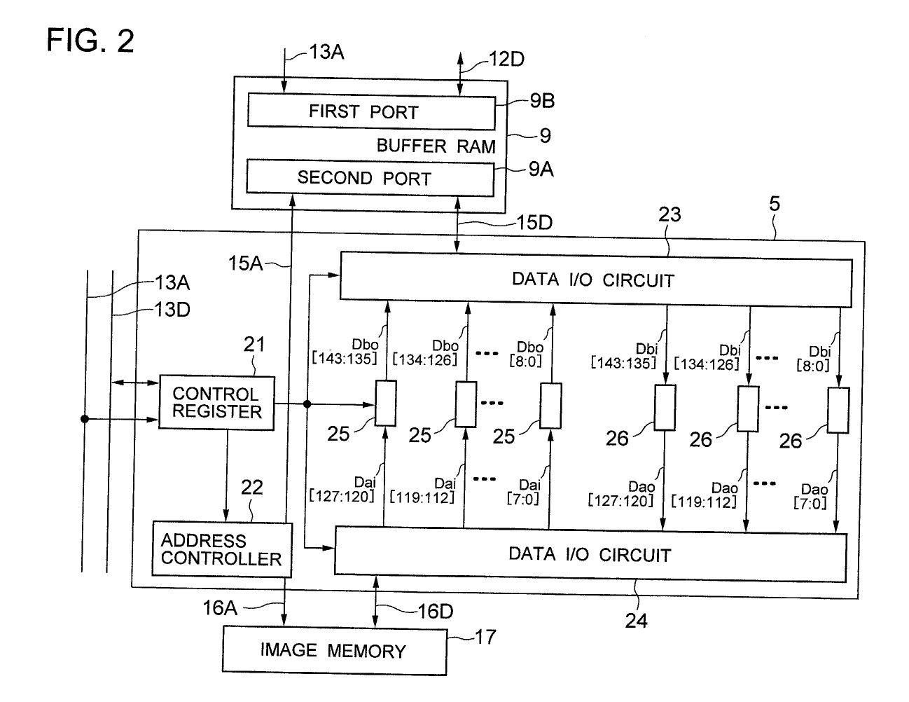

FIG. 2 shows in detail an example of the data transfer controller 5. The controller 5 includes a control register section 21, an address control circuit 22, a data input/output circuits 23, 24 a bit extension circuit 25 for code expansion, and a bit removal circuit 26 as a code removal circuit to remove code bits.

The CPU 2 sets a data transfer control condition and a code extension condition to the control register section 21. According to the data transfer control condition, the address controller 22 conducts access control operations, representatively, address control for the image memory 17 as well as access control operations, representatively, address control for the buffer RAM 9.

The buffer RAM 9 includes, although not limited to, a dual-port RAM including a dual port, i.e., a first port 9B and a second port 9A. The second port 9A is connected to the data transfer controller 5 to receive an access control signal from the address controller 22. The first port 9B is connected to the CPU address bus 13A and the data bus 12D to receive an access control signal from the CPU 2. Although not particularly limited to, the buffer RAM 9 includes a memory array in which a large number of memory cells are arranged in a form of a matrix. Word lines connected to the selection terminals of associated memory cells and bit lines connected to data input/output terminals of associated memory cells are disposed for each of the ports 9A and 9B. Therefore, the memory cells can be accessed completely in a concurrent fashion from the ports.

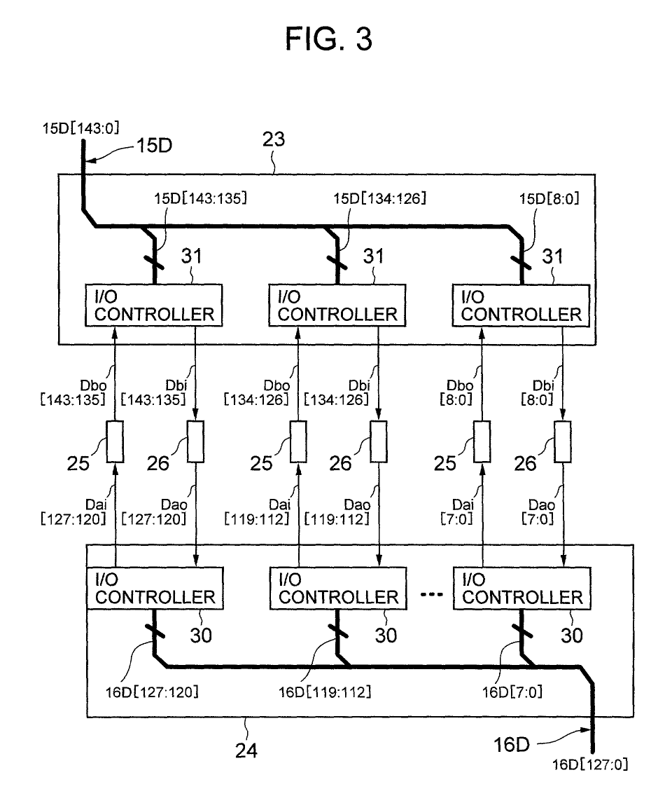

The data input/output circuit 24 is connected to eight input/output controller units 30 each of which is divided into 8-bit sections as shown in FIG. 3. A 128-bit data bus 16D includes 128 signal lines 16D[127:0] in which eight groups of eight signal lines, specifically, 16D[7:0] to 16D[127:120] beginning at a lower-most position are connected to the associated input/output controller units 30, respectively. For example, the lower-most input/output controller unit 30 controls connection between eight signal lines 16D[7:0] to 8-bit internal signal lines Dai[7:0] in an input operation and connection between eight signal lines 16D[7:0] to 8-bit internal signal lines Dao[7:0] in an output operation. The other input/output controller units 30 are also connected respectively to the associated signal lines to control the input and output operations. Each of the input/output controller units 30 includes on a signal input side an edge-trigger-type flip-flop circuit for each bit and has a function to shape a waveform of input data using a latch operation of the flip-flop circuit.

The data input/output circuit 23 is connected to eight input/output controller units 31 each of which is divided into 9-bit sections similarly as shown in FIG. 3. A 144-bit data bus 15D includes 144 signal lines 15D[1144:0] in which eight groups of nine signal lines, specifically, 15D[8:0] to 15D[144:135] beginning at a lower-most position are connected to the associated input/output controller units 30, respectively. For example, the lower-most input/output controller unit 31 controls connection between nine signal lines 15D[8:0] to 9-bit internal signal lines Dbi[8:0] in an input operation and connection between nine signal lines 15D[8:0] to 9-bit internal signal lines Dbo[8:0] in an output operation. The other input/output controller units 30 are also connected respectively to the associated signal lines to control the input and output operations. Each of the input/output controller units 31 includes on a signal input side an edge-trigger-type flip-flop circuit for each bit and has a function to shape a waveform of input data using a latch operation of the flip-flop circuit.

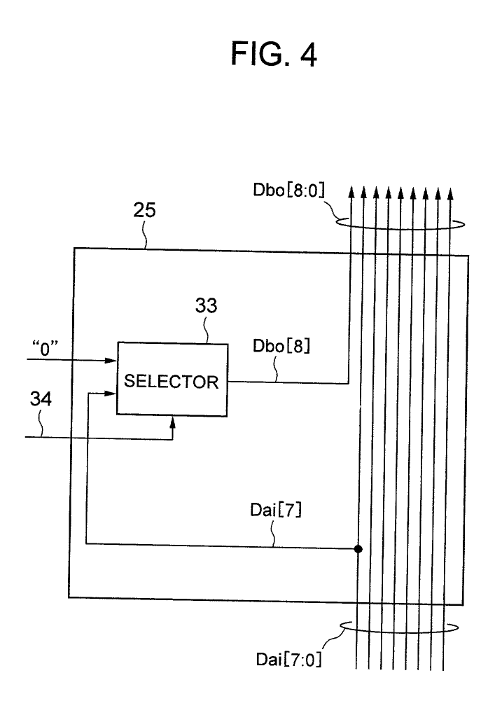

The bit extension circuit 25 receives, for example, the 8-bit internal signal line Dai[7:0] such that a higher-most bit Dai[7] is fed to the selector circuit 33 as shown in FIG. 4. In a state in which the higher-most bit Dai[7] is being selected by the control line 34, “0” is selected when the input Dai[7] is “0” and “1” when the input Dai[7] is “1”. The selected value is outputted as Dbo[8]. Dai[7:0] matches Dbo[7:0]. Resultantly, the code extension is conducted for the higher-most bit Dai[7] of Dai[7:0] to produce Dbo[8:0]. When a “0” insertion mode is selected in response to the control line 34, the higher-most bit Dbo[8] is fixed to “0”. The other bit extension circuits 25 are similarly connected to the respectively associated signal lines and the 1-bit code extension is carried out.

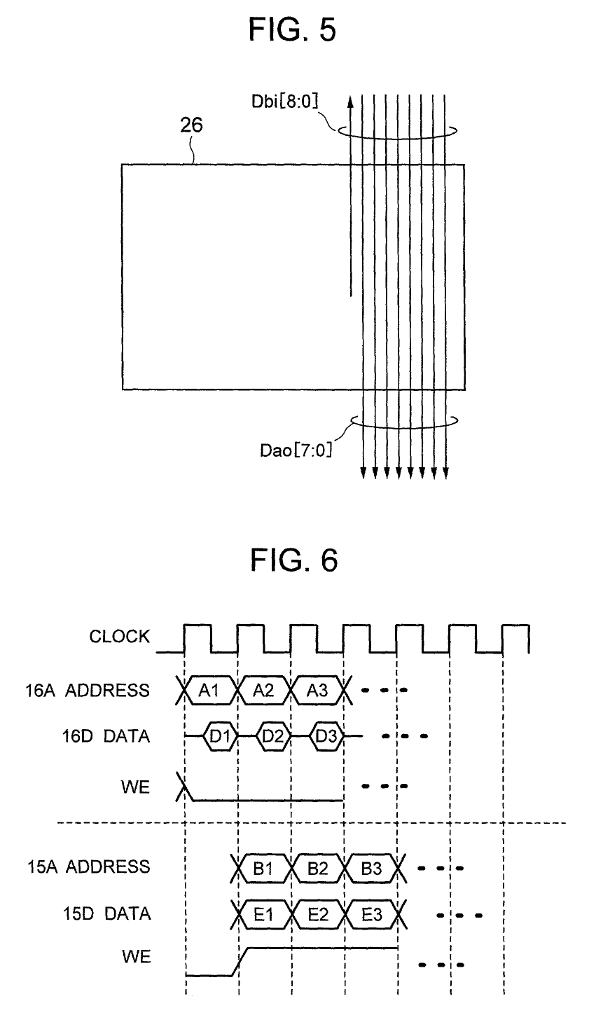

The bit removal circuit 26 is connected to the 8-bit internal signal lines Dao[7:0] via the 9-bit internal signal lines Dbi[8:0], for example, without using the higher-most bit Dbi[8] as shown in FIG. 5. In short, the internal signal lines Dao[7:0] are connected to the internal signal lines Dbi[7:0]. The other bit removal circuits 26 are also connected to the respectively associated signal lines in the similar manner and the 1-bit code removal is carried out.

Next, description will be given of the operation of the data transfer controller 5 to transfer image data from the image memory 17 to the buffer RAM 9.

First, the CPU 2 sets a transfer control condition and the like via the address bus 13A and the data bus 13D to the control register section 21 and then “1” to a transfer enable bit. This makes the data transfer controller 5 initiate a data transfer control operation. The controller 5 outputs a read address and the like to the image memory 17 using the address controller 22. For example, an address A1 is outputted in the signal timing chart of FIG. 6. In response thereto, 128-bit read data (data D1 in FIG. 6) is fed to the data bus 16D of the image memory 17 and is then delivered to the data input/output circuit 24. In the circuit 24, the bits of the read data are latches respectively by the flip-flop circuits of edge trigger type. The 128-bit read data is subdivided to be fed to 8-bit data signal lines Dai[7:0] to Dai[127:120]. The signals are then fed to eight bit extension circuits 25, respectively. The circuit 25 checks the higher-most bit of the received signal and conduct the bit extension to produce a 9-bit signal. The resultant signal is outputted in 9-bit unit to the data signal lines Dbo[8:0] to Dbo[143:135]. The 144-bit data sent to the signal lines Dbo[8:0] to Dbo[143:135] is delivered via the data input/output circuit 23 to the data bus 15D. The output data is indicated as E1 in FIG. 6. At timing synchronized therewith, the address controller 22 outputs an address of transfer destination (B1 in FIG. 6) to the buffer RAM 9. Therefore, the signed 144-bit image data is stored via the second port 9A in the buffer RAM 9.

The timing chart of FIG. 6 shows the sequence of data transfer operation described above. When address signals A1 to A3 are sequentially supplied from the address bus 16A to the image memory 17, the memory 17 outputs in response thereto 128-bit data items D1 to D3 to the data bus 16D. For the data, the code extension unit 25 conducts the code extension for every eight bits. The resultant 144-bit data items E1 to E3 are sequentially outputted with a 1-clock delay therebetween to the bus 15D and are then sequentially stored in the buffer RAM 9 according to address signals B1 to B3 from the address bus 15A.

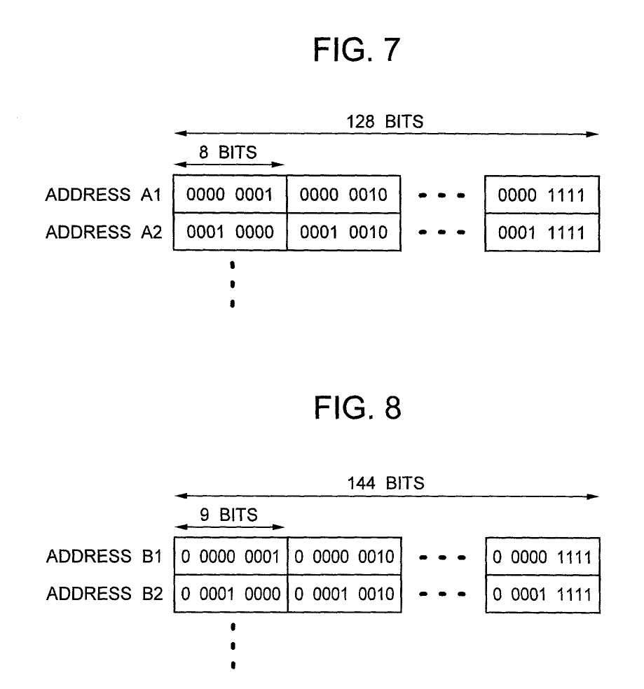

FIG. 7 shows an example of a state of data stored in the image memory 17. Data is stored in 8-bit unit in the memory having a width of 128 bits. When the data is transferred to the buffer RAM 9 by the data transfer controller 5 having the code extension function, the data is stored therein, for example, as shown in FIG. 8. As can be seen from the data layout, the code extension is conducted for every eight bits of the image data to produce signed 9-bit image data. Resultantly, 144-bit data is stored in the buffer RAM 9.

Therefore, the SIMD unit 3 can obtain the signed image data from the buffer RAM 9. The SIMD unit 3 then efficiently achieve a signed operation necessary for the code extension processing.

Concurrent Processing of SIMD Operation and DMA Transfer

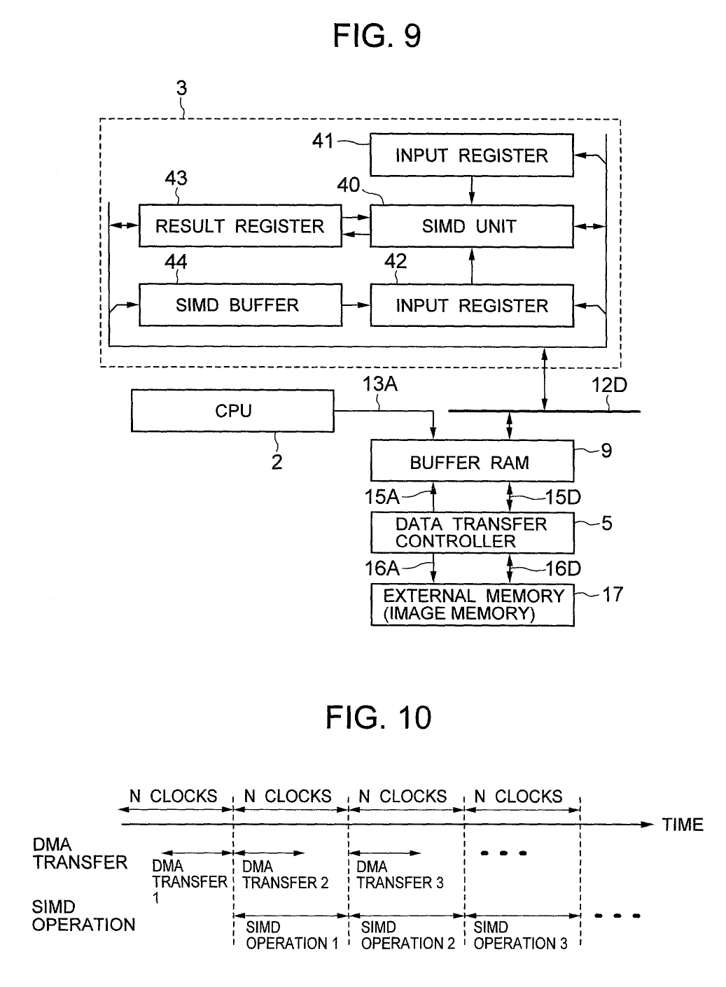

FIG. 9 shows an example of the SIMD unit 3. The SIMD unit 3 includes a 144-bit SIMD operator 40, 144-bit input registers 41 and 42 each of which keeps input data of the SIMD operator 40, a result resistor 43 to keep a result of operation conducted by the SIMD operator 40, and an SIMD buffer 44. The SIMD operator 40 includes, for example, a 144-bit arithmetic logic unit. The SIMD buffer 44 delivers data to the input register 42. The buffer 44 has a function to feed 9-bit data to the register 42 at an interval of one clock signal or one clock. The register 42 conducts a 9-bit shift so that data is inserted from the SIMD buffer 44 into the 9-bit area reserved by the shift operation. Therefore, during a period of time to sequentially feed the 144-bit data from the SIMD buffer 44, namely, during a period of 16 clocks, the SIMD operator 40 can conduct an operation with a register 41 and a register 42 in which data is updated for each clock. A resultant value of operation is accumulated in the result register 43. This means that during the sequence of operation, it is not necessary for the SIMD operator 40 to access the buffer RAM 9 for each clock cycle. The sequence of control operation is controlled by control signals from the CPU 2.

FIG. 10 shows an operation timing of the DMA transfer control by the data transfer controller 5 and the SIMD operation by the SIMD unit 3. For example, during a first period of n clock cycles (DMA transfer 1 of FIG. 10), data is transferred from the external memory (image memory) 17 to the buffer RAM 9 conducting the bit extension. In a subsequent period of n clock cycles, the CPU 2 accesses via the first port 9B the buffer RAM 9 and transfers necessary data items to the registers 41 and 42 and the SIMD buffer 44. Thereafter, during a period of 16 clocks (SIMD operation 1 of FIG. 10, the SIMD operator 40 achieves an operation between the register 41 and the register 42 in which data is updated for each clock. The SIMD operator 40 then accumulates a result of the operation in the register 43. In concurrence with the operation of the SIMD unit 3 in the period of SIMD operation 1 (DMA transfer 2 of FIG. 10), the data transfer controller 5 controls an operation to transfer data necessary for subsequent SIMD operation from the external memory 17 to the buffer RAM 9.

In concurrence with the SIMD operation by the SIMD operator 3 for the data read from the buffer RAM 9, the controller 5 can control an operation to transfer data necessary for subsequent operation to the buffer RAM 9. As above, the DMA transfer can be conducted during the SIMD operation, and hence the period of time used for the actual DMA transfer becomes invisible in the processing time. As a result, SIMD operation performance of the data processor 1 is increased. The SIMD operator 40 is always in a state in which necessary data with the code extension is prepared for operation. This increases operation efficiency of the SIMD operator 40.

Pseudo-Dual Port

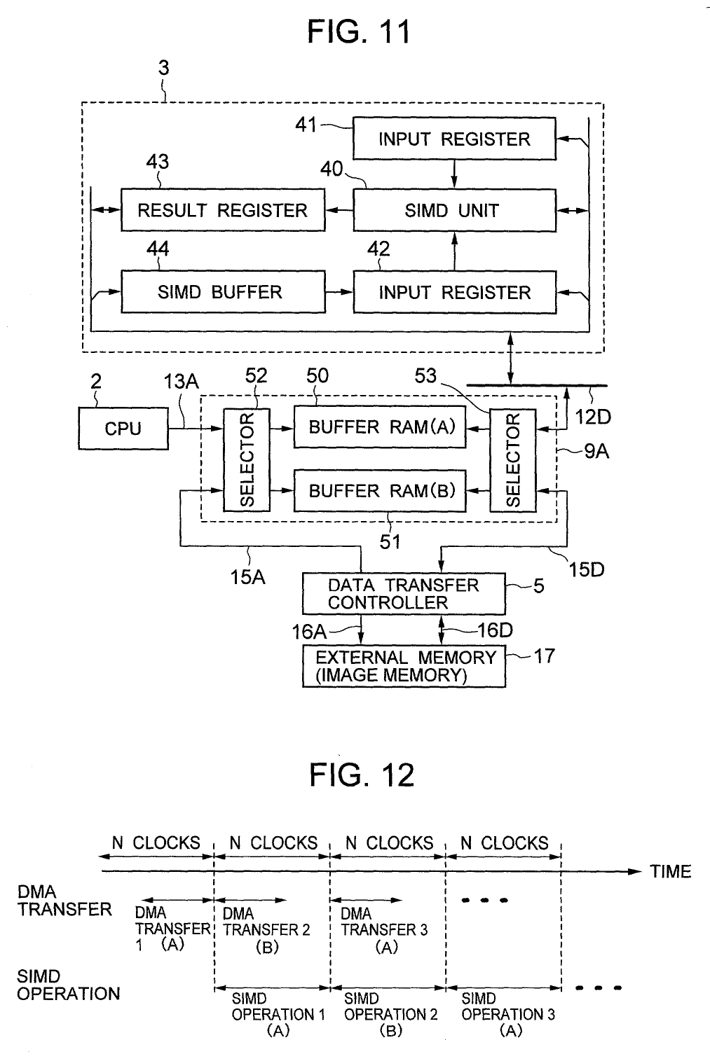

FIG. 11 shows an example of the buffer memory using a pseudo-dual port memory. The buffer memory 9A includes two buffer RAMs, i.e., a buffer RAM (A) 50 and a buffer RAM (B) 51. A selector circuit 52 selects a state of connections between address buses 13A and 15A and the buffer RAM (A) 50 and the buffer RAM (B) 51. A selector circuit 53 selects a state of connections between data buses 12D and 15D and the buffer RAM (A) 50 and the buffer RAM (B) 51. In short, when one of the buffers RAM (A) 50 and (B) 51 is connected to the SIMD unit 3, the other one can be connected to the data transfer controller 5 so that the buffer RAM (A) 50 and the buffer RAM (B) 51 are accessed in a concurrent fashion. The selection of the selectors 52 and 53 is controlled, for example, completely by the CPU 2 or by one of the CPU 2 as an accessing unit and the data transfer controller having an access right.

FIG. 12 shows operation timing of the SIMD operation and the DMA transfer. In the configuration of FIG. 11, operation of the SIMD operator 40 is the same as that described in conjunction with FIGS. 9 and 10. However, operation to control selection of the buffer RAMs 50 and 51 differs from that described above. Using the selectors 52 and 53, the buffer RAM (A) 50 is connected to the buses 15A and 15D and then the buffer RAM (B) 51 to the buses 13A and 12D. In this state, during a first period of n cycles (a period of DMA transfer 1(A) of FIG. 12), the data transfer controller 5 transfers image data from the external memory 17 to the buffer RAM (A) 50. In a subsequent period of n cycles (a period of DMA transfer 2(B) of FIG. 12), the selection state established by the selectors 52 and 53 is reversed such that the data transfer controller 5 controls an operation to transfer image data from the external memory 17 to the buffer RAM (B) 51. In concurrence with the DMA transfer (SIMD operation 1(A) of FIG. 1), the SIMD operator 40 conducts an operation using data beforehand transferred to the buffer RAM (A) 50. After a lapse of n clocks, the selection state established by the selectors 52 and 53 is again reversed. In this state (a period of DMA transfer 2(B) of FIG. 12), the SIMD operator 40 conducts an operation using data stored in the buffer RAM (B) 51. Simultaneously, an operation is started to transfer data for a subsequent SIMD operation to the buffer RAM (A) 50(a period of DMA transfer 3(A) of FIG. 12).

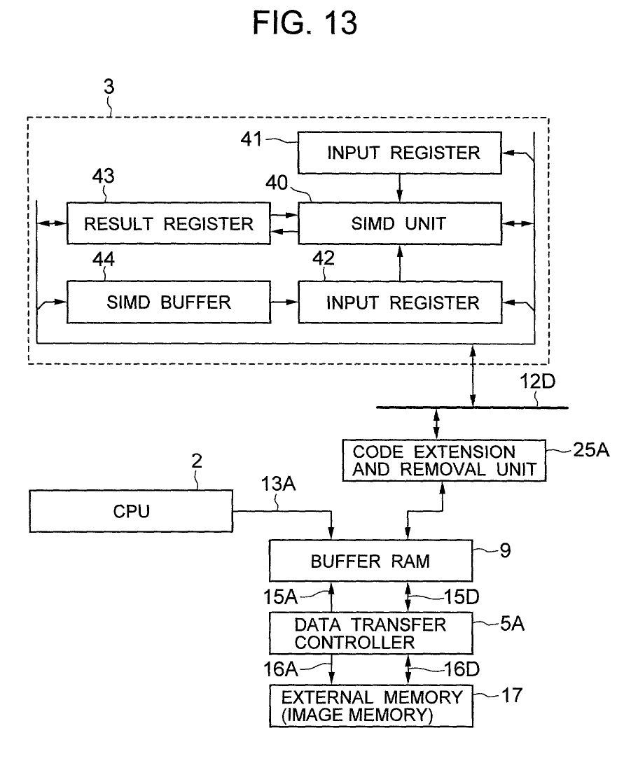

By achieving the operation, the buffer memory 9A can implement a function almost equal to a buffer memory of a complete dual port configuration. For each of the buffer RAMs 50 and 51, a single port RAM can be used, and it is not required that each memory cell includes a word line and a bit line for each port. Therefore, an area occupied by the buffer memory 9A can be reduced. Other advantages in the improvement of operation efficiency are equal to those described above. However, attention must be paid to the increase of the selection control operation for the selector circuits 52 and 53. Separated arrangement of code extension code removal circuit FIG. 13 shows an example in which a code extension and removal circuit 25A having the functions of the code extension circuit 25 and the code removal circuit 26 is arranged outside the data transfer controller. The circuit 25A is disposed between the buffer RAM 9 and the data bus 12D. The circuit 25A is configured in substantially the same way as for those shown in FIGS. 4 and 5. The circuit 25A achieves code extension for image data being transferred from the buffer RAM 9 to the SIMD unit 3. The circuit 25A achieves code removal for a result of an operation by the SIMD operator 3 when the result is written in the buffer RAM 9. In this situation, it is not required for a data transfer controller 5A to have a bit removal function. In other words, the controller 5A may be a simple direct memory access controller (DMAC).

In the configuration of FIG. 13, the code extension and removal circuit 25A increases the load (parasitic capacity and wiring resistance) imposed on the data bus 12D is increased. Attention must be paid to a disadvantageous event that the increase in the load also increases the signal delay and hence the data transfer speed of the data bus 12D is lowered depending on cases.

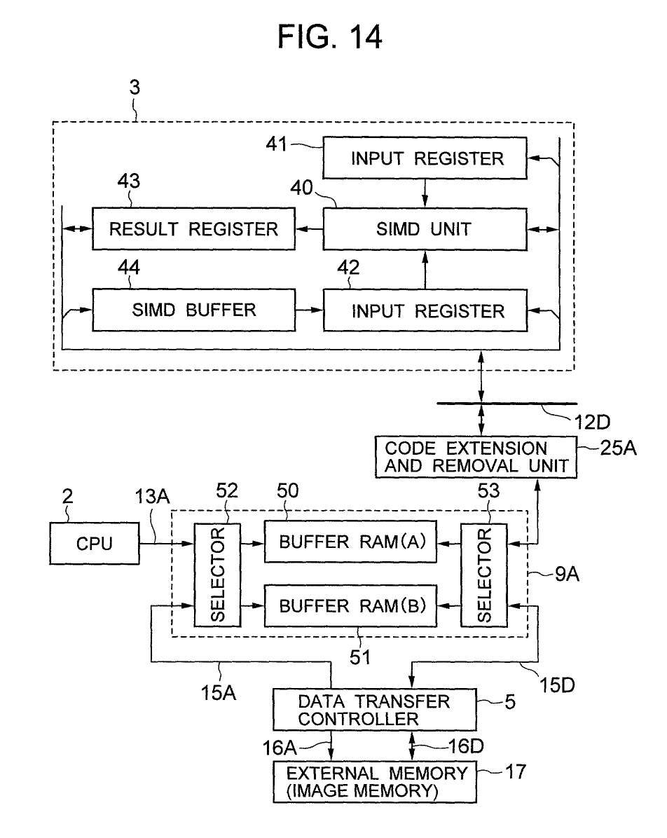

The two-side buffer RAM described in conjunction with FIG. 11 may also be used in the configuration of FIG. 13. In this case, the code extension and removal circuit 25A is arranged between the selector circuit 53 and the data bus 12D as can be seen from FIG. 14.

Also in the configurations shown in FIGS. 13 and 14, the SIMD operation efficiency can be increased.

Data Aligner

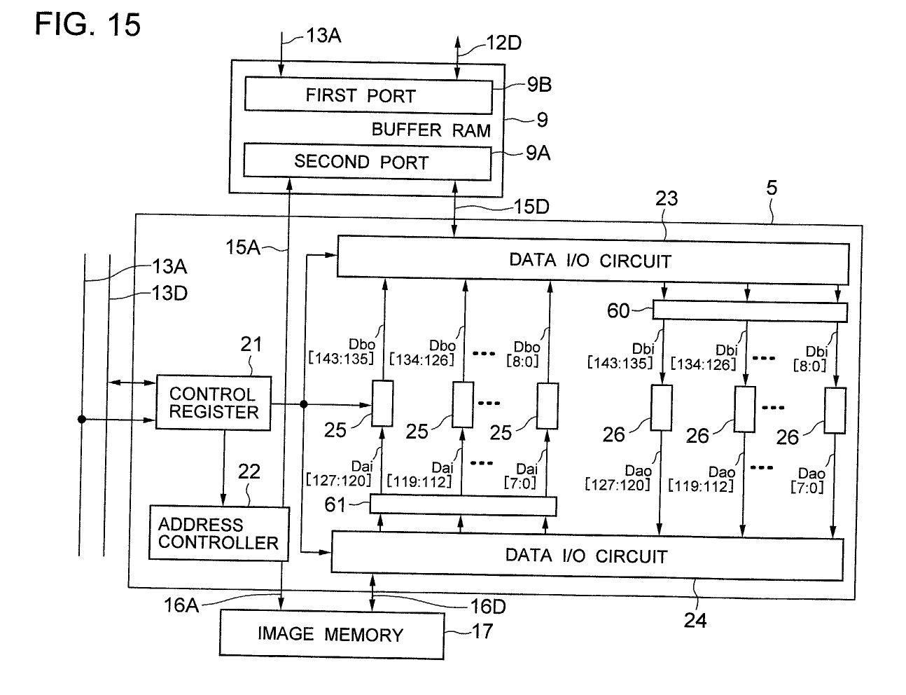

FIG. 15 shows an example in which a data aligner function is added to the data transfer controller 5. A data aligner 61 is disposed between the data input/output circuit 24 and the bit removal circuit 25. A data aligner 60 is disposed between the data input/output circuit 23 and the bit removal circuit 26. The other configuration is the same as that described in conjunction with FIG. 2. The same constituent components as those of FIG. 2 are assigned with the same reference numerals, and hence detailed description thereof will be avoided.

In the circuit configuration shown in FIG. 15, when data is transferred, for example, from the image memory 17 to the buffer RAM 9, the data aligner 61 aligns the data. The bit extension circuit 25 conducts code extension for the data aligned by the aligner 61. Although not limited to, the data aligner 61 has a 8-bit shift function. By repeatedly conducting a 128-bit data input many times, the data aligner 61 aligns image data extending over an 128-bit data boundary and sends the aligned data to the code extension circuit 25. When image data is transferred from the buffer RAM 9, a data aligner 60 aligns the data. The code removal circuit 26 removes predetermined part of the data aligned by the aligner 60. Although not limited to, the data aligner 60 has a 9-bit shift function. By repeatedly conducting a 144-bit data input many times, the data aligner 60 can send data extending over a 144-bit data boundary to the image memory 17. Although not limited to, the shift control operation is also accomplished according to control data set to the control register section 21.

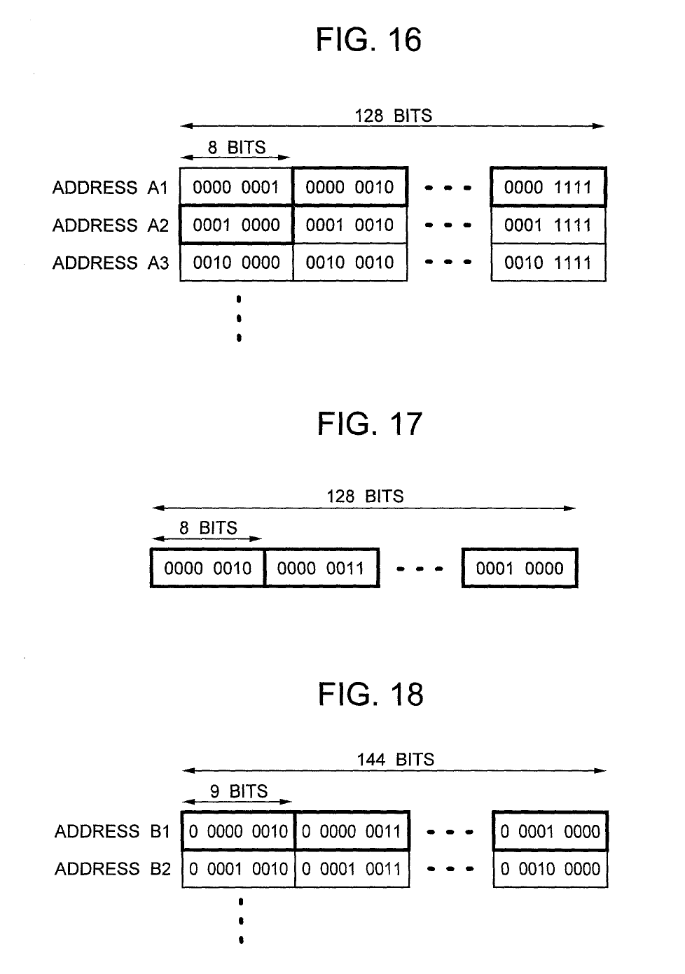

An example of the data alignment will be described. Assume that data is stored in the image memory 17, for example, as shown in FIG. 16. Assume in this situation that data necessary for the SIMD unit 3 includes bits ranging from bit 0 to bit 120 of a field beginning at address A1 and bits ranging from bit 120 to bit 127 of a field beginning at address A2. First, 128 bits beginning at address A1 are fed to the data input/output circuit 24, the data is latched by a latch in a first stage of the data aligner 61 to shift the data by eight bits to a higher-order (left) side, and the data shifted as above is held in a subsequent latch. Next, 128 bits beginning at address A2 are fed to the data input/output circuit 24, the data is latched by the latch in the first stage of the data aligner 61 to shift the data by 120 bits to a lower-order (right) side, and the data shifted as above is held in a subsequent latch. Resultantly, aligned 128-bit data is obtained as shown in FIG. 17. The data is fed to the code extension circuit 25 for code extension of the data. As a result, 144-bit image data for which the code extension has been conducted is stored in the buffer RAM 9.

The data transfer controller 5 has the data alignment function. Therefore, the SIMD unit 3 does not require the data alignment operation, which is necessary before and which is achieved by, for example, bit shift operation. The SIMD operation efficiency is accordingly increased.

IP Module Data

To facilitate the designing of the data processor 1 implemented as a semiconductor integrated circuit, designing data of the data transfer controller 5 and the like or designing data of the data processor 1 itself is supplied as so-called “IP module”.

Description will now be given of the IP module.

Circuit module data supplied as the IP module includes graphic pattern data or function description data prepared using a hardware description language (HDL) and a register transfer logic (RTL) to form the data processor 1 on the semiconductor chip. The graphic pattern data includes, for example, mask pattern data or electron-beam lithography data. The function description data is so-called program data. By reading the program data by a predetermined design tool, circuits and the like can be identified by symbols displayed on a display device or the like.

It is not required that the IP module is at a large-scale integration (LSI) level such as a data processor shown in FIG. 1. That is, the IP module may be at a circuit module level such as the data transfer controller.

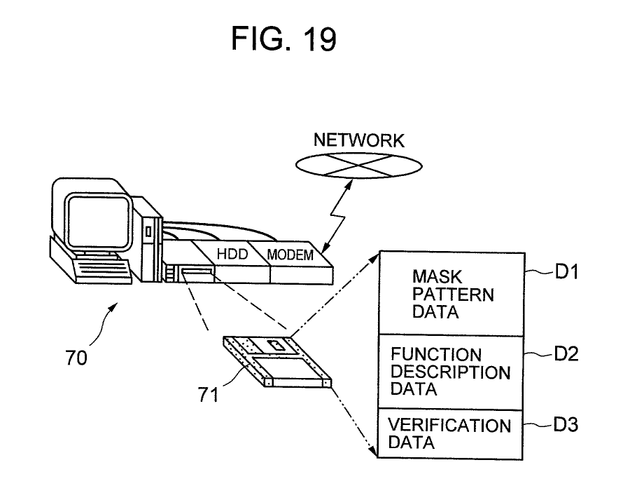

The IP module data is data which is used to design, by a computer 70 as a design tool, an integrated circuit to be formed on a semiconductor chip as shown in FIG. 19. The data is stored by the computer 70 on a computer-readable recording medium 71 such as a flexible disk, a compact-disk read-only memory (CD-ROM), a digital video disk ROM (DVD-ROM), or a magnetic tape. The data is also supplied through a transfer operation thereof using a transmission medium capable of data transmission and reception. The transmission medium is a network connected, for example, to a modem. The recording medium may be a hard disk (HDD). For example, data of the IP module corresponding to the data processor 1 of FIG. 1 includes mask pattern data D1 to configure the data processor 1, function description data D2 of the data processor 1, and verification data D3 which is used, when an LSI device is designed using the IP module data of the data processor 1, for simulation of the IP module in consideration of relationships with other modules.

By using the circuit module data of the data processor 1 stored on the recording medium 71 described above to design a semiconductor integrated circuit, the designing will be facilitated.

Embodiments of the present invention of the present inventor has been described in detail. However, the present invention is not restricted by the embodiments and can be changed in various ways within the scope of the invention.

For example, the circuit module on the chip of the semiconductor integrated circuit is not restricted by the configuration shown in FIG. 1. For example, the function of the DCT circuit may be implemented by software of the CPU. The image memory is not limited to an external memory, namely, an on-chip synchronous DRAM may also be used. The data transfer control method of the data transfer controller is not restricted by the configuration in which a transfer source address and a transfer destination address are initially set by the CPU as in the DMAC. It is also possible to employ a configuration in which a transfer condition is beforehand stored in a memory such that in response to a transfer request, a necessary transfer condition is obtained from the memory for the operation.

According to the present invention, the bit extension may include any extension other than the code extension.

The IP module data may be software IP module data. That is, excepting the mask pattern data D1 of FIG. 19, the software IP module data is the design data including the function description data D2 and the verification data D3.

The present invention is not limited to a case of application to compression and expansion of image data of the MPEG standards, but can also be widely applicable to compression and expansion, modulation and demodulation, and coding and decoding of other information such as audio or voice data.

Representative advantages obtained by the present invention described in the specification are as follows.

In concurrence with the operation of the SIMD section, data for a subsequent operation is transferred to the data buffer. The internal transfer of data to the data buffer therefore does not interrupt operation of the SIMD section. That is, the SIMD section can continuously conduct the operation and hence operation efficiency thereof is increased.

By disposing a bet extension function in the data transfer controller, necessary code extension can be carried out in the data transfer control operation. This also increases the SIMD operation efficiency.

By adding a data alignment function to the data transfer controller, data in an arbitrary pixel unit necessary for SIMD operation can be prepared for the data transfer, and hence performance to execute SIMD operation can be increased.

To shape necessary data, for example, to align the data in a data register of the SIMD operator, it is not required to execute a combination of instructions including a data shift instruction. Therefore, the SIMD operator can conduct operation more efficiently.

When a computer-readable recording medium having stored thereon circuit module data of a semiconductor integrated circuit according to the present invention to the user, the user can easily design the semiconductor integrated circuit using the circuit module data.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A semiconductor integrated circuit, comprising:
a single instruction multiple data (SIMD) unit conducting a concurrent operation for a plurality of data items;
a data buffer connectable to said SIMD unit; and
a data transfer control unit for controlling transfer of data for said data buffer, wherein
said data transfer control unit controls the transfer of data for a subsequent operation to said data buffer in concurrence with the operation of said SIMD unit for the plural data items read from said data buffer.

2. A semiconductor integrated circuit according to claim 1, wherein said data buffer includes a dual-port unit including a first port and a second port,
said first port being connected via a first bus to said SIMD unit,
said second port being connected via a second bus to said data transfer control unit.

3. A semiconductor integrated circuit according to claim 2, wherein:
said first port concurrently input and output the plurality of data items for said first bus; and
said second port concurrently input and output the plurality of data items for said second bus.

4. A semiconductor integrated circuit according to claim 3, wherein said SIMD unit includes:
a first data register connected to said first bus, said first data register being concurrently latched the plurality of data items;
a second data register connected to said first bus, said first data register being concurrently latched the plurality of data items; and
an operator for receiving the plurality of data items respectively latched by said first and second data registers and for conducting a concurrent operation for the data items.

5. A semiconductor integrated circuit according to claim 2, further comprising a central processing unit conducting operation control for said SIMD unit and access control via said first bus to said data buffer.

6. A semiconductor integrated circuit, comprising:
a single instruction multiple data (SIMD) unit conducting a concurrent operation for a plurality of data items;
a data buffer connected via a first bus to said SIMD unit; and
a data transfer control unit connected via a second bus to said data buffer, wherein
said data transfer control unit includes a bit extension unit for conducting bit extension for each of the plurality of data items transferred via said second bus to said data buffer.

7. A semiconductor integrated circuit according to claim 6, wherein said bit extension unit conducts 1-bit code extension according to a lower-most bit of the data.

8. A semiconductor integrated circuit according to claim 6, wherein said bit extension unit conducts bit extension for the plurality of data items in a concurrent fashion.

9. A semiconductor integrated circuit according to claim 6, further comprising a data aligner in a stage before said bit extension unit for the plurality of data items.

10. A semiconductor integrated circuit according to claim 6, wherein said data transfer control unit includes a bit removal unit for removing bits from each of the plurality of data items which are read from said data buffer and which are transferred via said second bus.

11. A semiconductor integrated circuit according to claim 10, wherein said bit removal unit removes a higher-most bit from the data.

12. A semiconductor integrated circuit according to claim 6, wherein said data buffer includes a dual-port unit including a first port and a second port,
said first port being connected via a first bus to said SIMD unit,
said second port being connected via a second bus to said data transfer control unit.

13. A semiconductor integrated circuit according to claim 12, wherein:
said first port concurrently input and output the plurality of data items for said first bus; and
said second port concurrently input and output the plurality of data items for said second bus.

14. A semiconductor integrated circuit according to claim 13, wherein said SIMD unit comprises:
a first data register connected to said first bus, said first data register being concurrently latched the plurality of data items;
a second data register connected to said first bus, said first data register being concurrently latched the plurality of data items; and
an operator for receiving the plurality of data items respectively latched by said first and second data registers and for conducting a concurrent operation for the data items.

15. A semiconductor integrated circuit according to claim 14, further comprising a central processing unit conducting operation control for said SIMD unit and access control via said first bus to said data buffer.

16. A semiconductor integrated circuit according to claim 15, wherein
said first and second data registers latch, in compression processing of image data, the image data;
said first data register latches, in expansion of image data, the image data; and
said second data register latches data of inverse discrete cosine transform (IDCT).

17. A semiconductor integrated circuit, comprising:
a single instruction multiple data (SIMD) unit conducting a concurrent operation for a plurality of data items;
a data buffer connectible to said SIMD unit;
a data transfer control unit for controlling transfer of data for said data buffer; and
a bit extension unit disposed on a data transfer path connecting said data buffer to said SIMD unit for conducting bit extension for each of the plurality of data items to said SIMD unit in a concurrent fashion.
